(19) United States
(12) Patent Application Publication
(10) Pub. No.: US 2008/0117731 A1
(43) Pub. Date: May 22, 2008

(54) DATA RECORDING AND REPRODUCING APPARATUS AND RECORDING LEARNING METHOD

(75) Inventors: Hiroyuki Moro, Tokyo (JP); Takahiro Nango, Tokyo (JP); Koichi Otake, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/848,113

(22) Filed: Aug. 30, 2007

(30) Foreign Application Priority Data
Nov. 17, 2006 (JP) 2006311879

(51) Int. Cl. G11B 7/00

(52) U.S. Cl. 369/44.26

(57) ABSTRACT

According to one embodiment, a data recording and reproducing apparatus includes: a reproduced signal output device reading data recorded on an optical recording medium to output a reproduced signal; and a waveform compensation amount data generating device generating waveform compensation amount data of a recording waveform corresponding to recording data which is to be recorded to the optical recording medium. At the time of recording learning, this data recording and reproducing apparatus integrates, for each pattern, waveform error data which are used as a basis of the generation of the waveform compensation amount data by the waveform compensation amount data generating device, and adjusts output of a pattern instruction signal for instructing which of the patterns is an integration target, so as to integrate, for each pattern, the waveform error data in a target test write area corresponding to an integer number of rotations of the optical recording medium.

### CROSS-REFERENCE TO RELATED APPLICATIONS

This application is based upon and claims the benefit of priority from Japanese Patent Application No. 2006-311879, filed Nov. 17, 2006, the entire contents of which are incorporated herein by reference.

### BACKGROUND

1. Field

One embodiment of the invention relates to a data recording and reproducing apparatus which records and reproduces data by using an optical disk, and a recording learning method in the data recording and reproducing apparatus.

2. Description of the Related Art

Conventional recording media to/from which digital data is recordable and reproducible include optical disks, typically, a DVD (digital versatile disk). Among them, in an optical disk, for example, in a DVD-RAM which is one of a DVD family, a signal recording layer is provided in a recording medium (disk), and when the recording layer is irradiated with a laser beam having an appropriate energy, a crystal state of the recording layer changes, and when the recording layer is irradiated again with a laser beam having an appropriate energy, reflected light in an amount according to the crystal state of the recording layer is obtained. Digital data is reproduced based on the detected reflected light.

Further, in conventional data recording and reproducing apparatuses, a technique called recording learning has been sometimes adopted in order to optimize a write state at the time of recording. The recording learning is to perform test recording of test data prior to recording of digital data, evaluate quality of a reproduced signal which is generated based on the test data read from a recording medium, and correct the digital data which is to be recorded.

An optical recording apparatus described in Japanese Patent Application Publication (KOKAI) No. 6-236553 (patent document 1) is one example of conventional arts relating to test recording of data to a recording medium. This optical recording apparatus performs test recording of an evaluation pattern having periodicity and detects the optimum recording condition by using the result of the reproduction of the evaluation pattern, thereby enabling compatibility.

Another example is a recording and reproducing apparatus disclosed in Japanese Patent Application Publication (KOKAI) No. 2000-231718 (patent document 2). This recording and reproducing apparatus writes a pattern signal of consecutive marks and spaces in a test recording area provided along one track and reproduces the pattern signal from the test recording area to find optimum shift amounts of a first pulse and a last pulse for a pattern of data, thereby enabling data recording at a correct position.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the circuit configuration in a data recording and reproducing apparatus according to an embodiment of the invention;

FIG. 2 is an exemplary view showing test write areas in an optical disk in the embodiment;

FIG. 3 is an exemplary view showing an example of detection patterns in the embodiment;

FIG. 4 is an exemplary graph showing an example of the frequency of appearance of the detection patterns in the embodiment;

FIG. 5 is an exemplary block diagram showing the circuit configuration in a pattern count adjusting unit in the embodiment;

FIG. 6 is an exemplary view schematically showing a relation between a test write area and units in the embodiment; and

FIG. 7 is an exemplary flowchart showing the procedure for the operation of adjusting the output of an adjusted pattern instruction signal executed by the pattern count adjusting unit in the embodiment.

### DETAILED DESCRIPTION

Various embodiments according to the invention will be described hereinafter with reference to the accompanying drawings. In general, according to one embodiment of the invention, a data recording and reproducing apparatus includes: a reproduced signal output device reading data recorded on an optical recording medium to output a reproduced signal; and a waveform compensation amount data generating device generating waveform compensation amount data of a recording waveform corresponding to recording data which is to be recorded to the optical recording medium. The data recording and reproducing apparatus further includes: a waveform error integrating device integrating, for each pattern, waveform error data which are used as a basis of the generation of the waveform compensation amount data by the waveform compensation amount data generating device; and an integration adjusting device adjusting output of a pattern instruction signal for instructing the waveform error integrating device which of the patterns is an integration target, so as to cause the waveform error integrating device to integrate, for each of the patterns, the waveform error data in a target test write area corresponding to an integer number of rotations of the optical recording medium.

Further, a recording learning method in a data recording and reproducing apparatus includes: integrating, for each pattern, waveform error data which are used as a basis of the generation of the waveform compensation amount data by the waveform compensation amount data generating device; and adjusting output of a pattern instruction signal for instructing which of the patterns is an integration target, so as to integrate, for each of the patterns, the waveform error data in a target test write area corresponding to an integer number of rotations of the optical recording medium.

(Configuration of the Data Recording and Reproducing Apparatus)

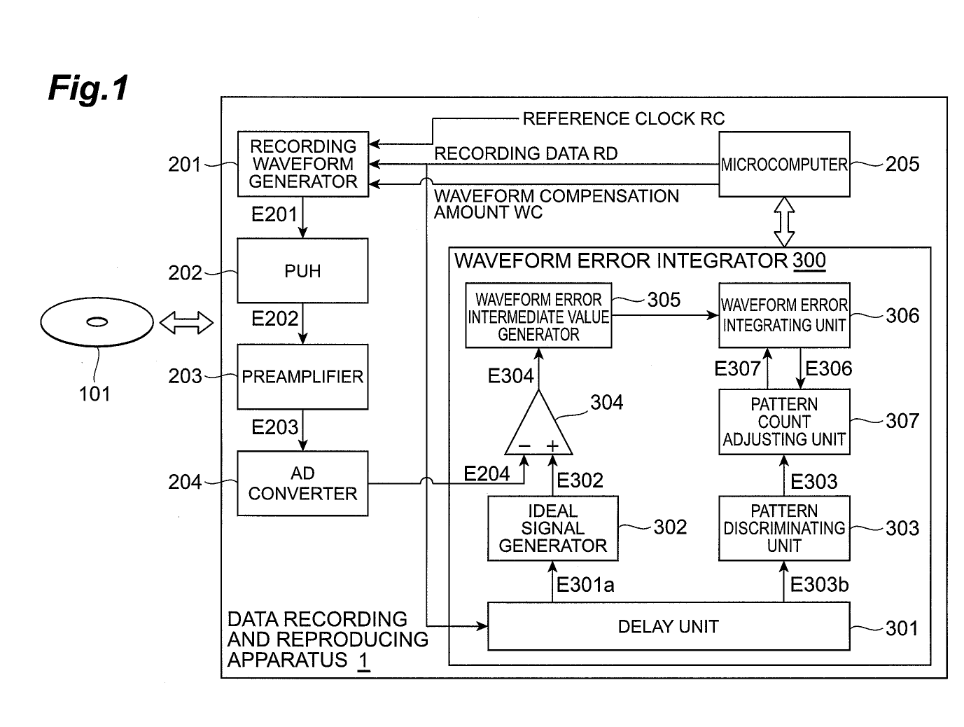

FIG. 1 is a block diagram showing the internal configuration of a data recording and reproducing apparatus 1 according to an embodiment of the present invention. As shown in FIG. 1, the data recording and reproducing apparatus 1 uses an optical disk 101 as an optical recording medium, and is capable of reproducing digital data recorded on the optical disk 101 and also capable of recording digital data to the optical disk 101. This data recording and reproducing apparatus 1 is capable of recording and reproducing data to/from a HD DVD. The data recording and reproducing apparatus 1 has a recording waveform generator 201, a PUH (Pick Up Head) 202 including an optical pickup and so on, and a preamplifier 203. The data recording and reproducing apparatus 1 further has an AD converter 204, a microcomputer 205, and a waveform error integrator 300.

The recording waveform generator 201 generates a recording waveform pulse E201 compensated of wave form appropriately (having undergone adaptive control) based on a reference clock RC, recording data RD, and waveform compensation amount data WC which are supplied thereto, and outputs the recording waveform pulse E201 to the PUH 202.

The PUH 202 records digital data to the optical disk 101 by using the recording waveform pulse E201. Further, the PUH 202 emits an appropriate laser beam to the optical disk 101 to detect reflected light from the optical disk 101 and outputs a weak analog reproduced signal E202 to the preamplifier 203. By the PUH 202, digital data recorded as marks/spaces (not shown) on the optical disk 101 is read as the analog reproduced signal E202.

The preamplifier 203 applies processing such as amplification to the analog reproduced signal E202 outputted from the PUH 202 and outputs, to the AD converter 204, an analog reproduced signal E203 which has reached a sufficiently high signal level. The AD converter 204 converts a level value of the inputted analog reproduced signal E203 into a digital value to output a digital reproduced signal E204. The digital reproduced signal E204 is supplied to the waveform error integrator 300. In this embodiment, the PUH 202 and the preamplifier 203 constitute a reproduced signal output device.

The waveform error integrator 300 has a delay unit 301, an ideal signal generator 302, and a pattern discriminating unit 303. The waveform error integrator 300 further has a subtractor 304, a waveform error intermediate value generator 305, a waveform error integrating unit 306, and a pattern count adjusting unit 307.

The delay unit 301 (delay device) delays the recording data RD which is to be recorded to the optical disk 101, to output a delayed signal E303b to the pattern discriminating unit 303 and output a binary pattern E301a to the ideal signal generator 302.

From the binary pattern E301a supplied from the delay unit 301, the ideal signal generator 302 generates an ideal signal E302 which is an ideal reproduced signal adapted to a used PR characteristic (partial response characteristic). The generated ideal signal E302 is supplied to the subtractor 304.

In the pattern discriminating unit 303 (pattern discriminating device), detection patterns (to be described later) of various kinds set in advance are registered (the registered detection patterns will be referred to as “registered patterns”). The pattern discriminating unit 303 discriminates which one of the registered patterns the delay signal E303b matches (or corresponds to). The pattern discriminating unit 303 outputs a pattern instruction signal E303 to the pattern count adjusting unit 307 when the delay signal E303b matches (or corresponds to) any of the registered patterns. The pattern instruction signal E303 indicates which of the registered patterns the delay signal E303b matches (or corresponds to).

The subtractor 304 performs subtraction on the digital reproduced signal E204 outputted from the AD converter 204 and the ideal signal E302 to generate an amplitude error signal E304.

The waveform error intermediate value generator 305 generates a waveform error intermediate value (waveform error data) E305 by using the amplitude error signal E304 to supply the waveform error intermediate value E305 to the waveform error integrating unit 306. The waveform error intermediate value E305 is used when the waveform compensation amount data WC is generated, and is base data for generating the waveform compensation data WC.

The waveform error integrating unit 306 has a function as a waveform error integrating device which integrates, for each pattern, the waveform error intermediate values E305. That is, the waveform error integrating unit 306 integrates, for each detection pattern, the waveform error intermediate values E305 supplied from the waveform error intermediate value generator 305. In this case, the waveform error integrating unit 306 performs the integration for each pattern while changing the detection pattern, according to an adjusted pattern instruction signal E307 (to be described later).

Further, the waveform error integrating unit 306 has a register, and stores, in the register, data patterns (data patterns will be described later) which are integrated for each of the detection patterns. Then, at an instant when an amount of the integrated data patterns exceeds an integration set value set by the microcomputer 205, the waveform error integrating unit 306 outputs end data ed indicating the completion of the integration of the data patterns, thereby notifying the microcomputer 205 that the integration of the data patterns has been completed.

The pattern count adjusting unit 307, which is an integration adjusting device, receives integration amount data E306 indicating an integration amount for each detection pattern from the waveform error integrating unit 306, and performs integration necessity determination, that is, determines whether or not the integration of the data patterns for the detection pattern discriminated by the pattern discriminating unit 303 is to be executed. Further, when it is determined, as a result of the integration necessity determination, that the integration of the data patterns is to be executed, the pattern count adjusting unit 307 outputs the later-described adjusted pattern instruction signal E307 (details will be described later).

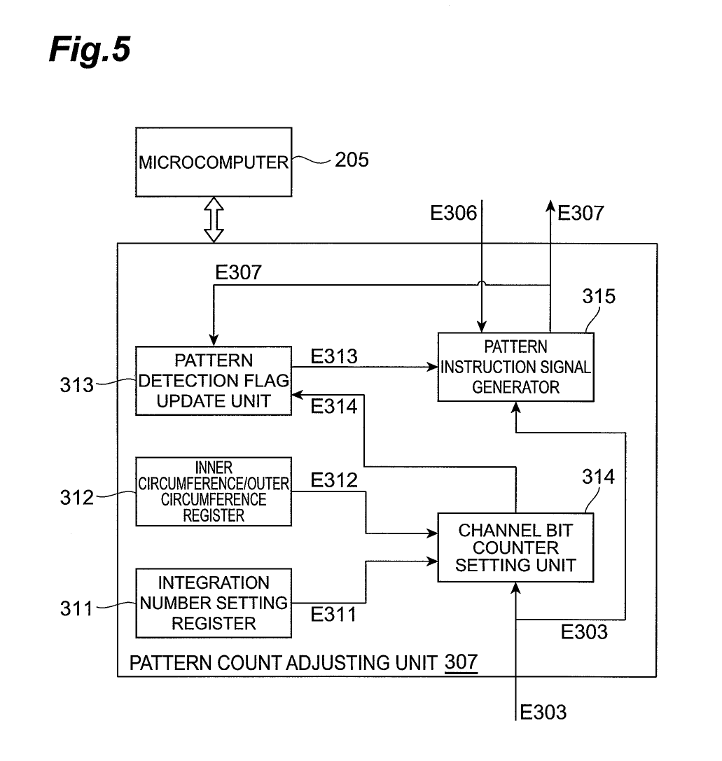

This pattern count adjusting unit 307 is shown in detail in FIG. 5 and will be described in detail later.

The microcomputer 205 has a function as a waveform compensation amount data generating device which reads the contents of the waveform error integrating unit 306 after a predetermined time has passed or at an instant when a predetermined amount of the data patterns has been integrated by the waveform error integrating unit 306, and generates the waveform compensation amount data WC. Further, the microcomputer 205 generates the recording data RD. The waveform compensation amount data WC and the recording data RD are supplied to the recording waveform generator 201.

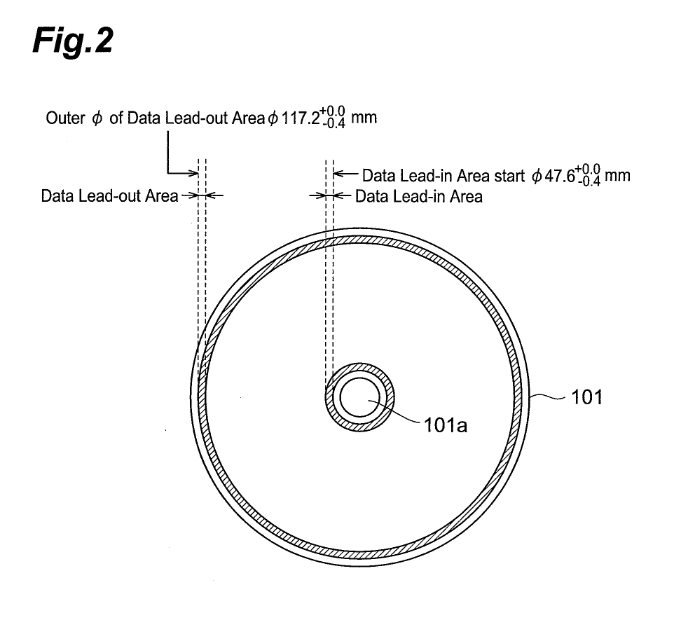

Next, the optical disk 101 will be described with reference to FIG. 2. FIG. 2 is a view showing where on the optical disk 101 test write areas are located. On the optical disk 101, the test write areas exist in a data lead-in area positioned along an inner circumference of the optical disk 101 and a data lead-out area positioned along an outer circumference thereof.

In a HD DVD, the data lead-in area and the data lead-out area are located at a 47.6 mm diameter position and a 117.2 mm diameter position with respect to the center of a center hole 101a of the optical disk 101. Therefore, taking pi as 3, the lengths of the data lead-in area and the data lead-out area are 142.8 mm and 351.6 mm respectively.

In a HD DVD-R which is one of recordable HD DVDs, the length of 1 channel bit is 0.102 μm. Therefore, the number of channel bits corresponding to one disk rotation is about 1,400,000 channel bits in the data lead-in area and about 3,450,000 bits in the data lead-out area.

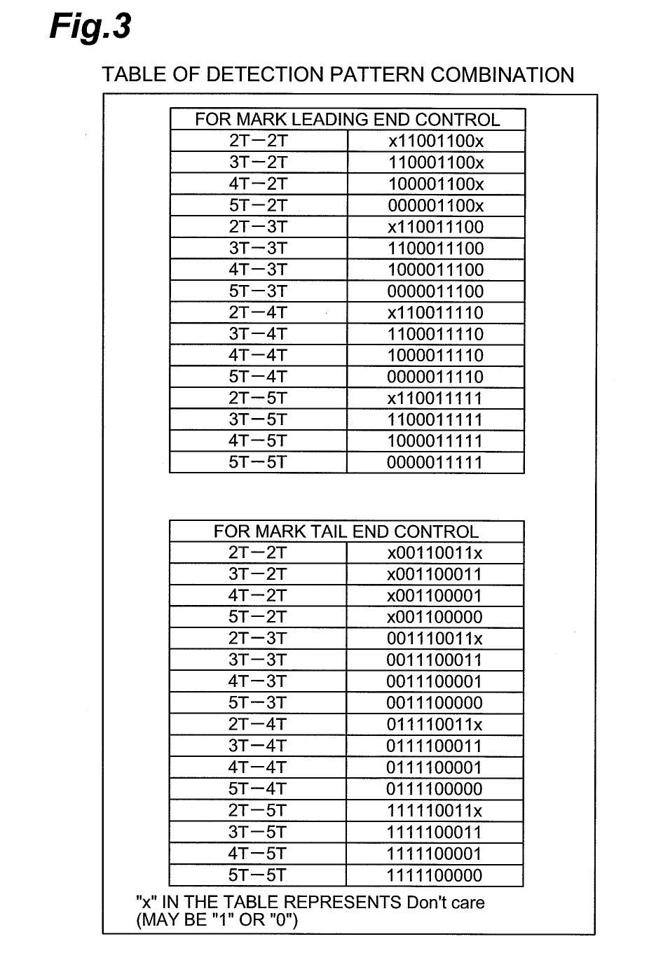

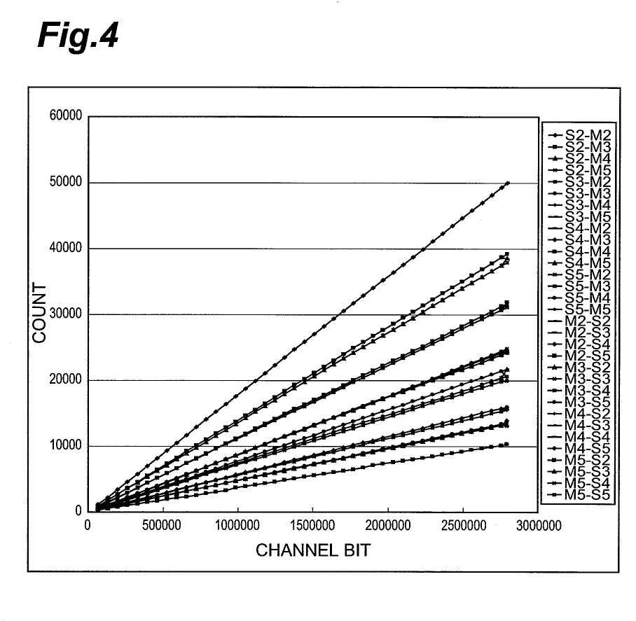

Next, the combination of patterns detected in the recording learning of a HD DVD will be described with reference to FIG. 3 and FIG. 4. FIG. 3 is a view showing the combination of patterns detected in the recording learning of the HD DVD (detection patterns). As shown in FIG. 3, in this embodiment, there are 32 kinds of detection patterns such as “2T-2T”, “3T-2T”, and “4T-2T”.

Further, FIG. 4 is a graph showing the frequency of appearance of the detection patterns. As shown in FIG. 4, it is seen that among 32 kinds of the detection patterns, the frequency of appearance of some of the detection patterns is high, while the frequency of appearance of some of the detection patterns is low, and the former and the latter are different by about five times. Therefore, with such a difference in the frequency of appearance among the detection patterns, a good effect of recording learning may be exhibited in some of the detection patterns but may not in some other detection patterns at the time of the recording learning.

Assuming a case where, for example, the optical disk 101 with large eccentricity is used at the time of the recording learning, the recording learning is executed in the following manner. Specifically, in the recording learning, all the detection patterns of 32 kinds are targets, and when a prescribed number of the data patterns have been detected for all the target detection patterns, the integration of the data patterns is finished.

In this case, even if the integration of the data patterns is performed based on reproduced signals obtained from the whole test write area corresponding to one rotation of the optical disk 101, as for the detection pattern with a high frequency of appearance, the integration is finished at the time when the integration of the data patterns has been performed based only on the reproduced signals obtained from the test write area corresponding to about ⅕ rotation of the optical disk 101. In this case, even if the optical disk 101 has eccentricity or wobbling, the influence of the eccentricity or wobbling may not be reflected in the recording learning.

Therefore, in the data recording and reproducing apparatus 1, to avoid such a situation, the pattern count adjusting unit 307 shown in FIG. 1 adjusts the output of a pattern instruction signal (in this embodiment, an adjusted pattern instruction signal E307) for instructing the waveform error integrating unit 306 which patterns should be integrated.

FIG. 5 is a block diagram showing the internal configuration of the pattern count adjusting unit 307. The pattern count adjusting unit 307 has an integration number setting register 311, an inner circumference/outer circumference setting register 312, a pattern detection flag update unit 313, a channel bit counter setting unit 314, and a pattern instruction signal generator 315.

An integration number E311 is set in the integration number setting register 311 by the microcomputer 205, and selection data E312 is set in the inner circumference/outer circumference setting register 312 by the microcomputer 205. The integration number E311 and the selection data E312 set in the integration number setting register 311 and the inner circumference/outer circumference setting register 312 respectively are read by the channel bit counter setting unit 314. Here, the integration number E311 indicates the number of data patterns to be detected regarding each detection pattern, and the selection data E312 indicates which of the data lead-in area and the data lead-out area is a target area of the recording learning (if the target area is the former, for example, “01” which is data indicating the inner circumference is set, and if the target area is the latter, for example, “99” which is data indicating the outer circumference is set).

Flags (detection flags) corresponding to the respective detection patterns are provided in the pattern detection flag update unit 313, each indicating whether or not the corresponding detection pattern has been detected. For example, the detection flag is set to “1” when the pattern instruction signal generator 315 has detected the corresponding detection pattern and is in a state where it can output the adjusted pattern instruction signal E307, and when the pattern instruction signal generator 315 has not detected the corresponding detection pattern, the detection flag is set to “0”. Therefore, from each of the detection flags, it can be determined whether or not the corresponding detection pattern has been detected. In a case where the 32 detection patterns shown in FIG. 3 are used in the recording learning, pattern flag data E313 has the detection flags corresponding to the 32 patterns.

When receiving the adjusted pattern instruction signal E307 from the pattern instruction signal generator 315, the pattern detection flag update unit 313 updates the set value of the corresponding detection flag of the pattern flag data E313 to “1”. The pattern detection flag update unit 313 has a function as a detection flag update device.

Further, when receiving a count completion signal E314 (to be described later) from the channel bit counter setting unit 314, the pattern detection flag update unit 313 clears the pattern flag data E313 so that the pattern flag data E313 indicates that all the detection patterns are undetected (that is, sets the detection flags to “0”). Consequently, the pattern instruction signal generator 315 comes to be capable of outputting the adjusted pattern instruction signal E307.

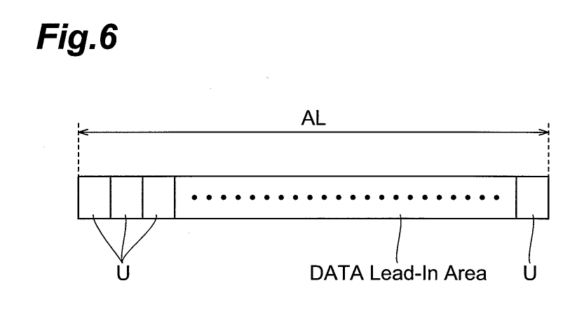

The channel bit counter setting unit 314 has a function as a setting device which sets whole-area count data (whole-area set value) based on the integration number E311 and the selection data E312. As shown in FIG. 6, the whole-area count data indicates how many units U can be obtained from a test write area AL corresponding to one disk rotation, the unit U being the number of channel bits corresponding to the integration number E311. The whole-area count data is set in order to evenly collect the data patterns based on the reproduced signals obtained from the whole target test write area, that is, the test write area AL corresponding to one rotation of the optical disk 101.

For example, if the integration number E311 is “500” (if 500 data patterns are to be detected) and “01” indicating the inner circumference is set in the selection data E312, the number of channel bits corresponding to one disk rotation is about 1,400,000 channel bits in the data lead-in area. The whole-area count data is a value resulting from the division of the number of channel bits of the test write area AL by the unit U, and therefore can be set to “2800”.

If the integration number E311 is “250” and “99” indicating the outer circumference is set in the selection data E312, the number of channel bits corresponding to one disk rotation is about 3,450,000 channel bits in the data lead-out area. Therefore, in this case, the whole-area count data can be set to “13800”.

The channel bit counter setting unit 314 also has a function as a channel bit counter update device. Specifically, every time it receives the pattern instruction signal E303 outputted from the pattern discriminating unit 303, the channel bit counter setting unit 314 adds the number of required channel bits (an average value of the number of channel bits required to detect one detection pattern) to a channel bit counter to update the channel bit counter.

The channel bit counter setting unit 314 also has a function as a count completion signal output device. Specifically, when the channel bit counter reaches the whole-area count data or more, the channel bit counter setting unit 314 outputs the count completion signal E314 to the pattern detection flag update unit 313, and at the same time, clears the channel bit counter and the whole-area count data to start counting again.

In this manner, the channel bit counter setting unit 314 adjusts the output timing of the count completion signal E314 so as not to output the count completion signal E314 until the channel bit counter reaches the whole-area count data.

The pattern instruction signal generator 315 determines whether to output the adjusted pattern instruction signal E307 or not in the following manner, based on the pattern instruction signal E303, the pattern flag data E313, and the integration amount data E306.

When receiving the pattern instruction signal E303, the pattern instruction signal generator 315 refers to the detection flag corresponding to the inputted pattern instruction signal E303, among the detection flags included in the pattern flag data E313.

Then, when the referred detection flag indicates that the detection pattern has been detected (that is, when “1” is set in the detection flag), the pattern instruction signal generator 315 does not output the adjusted pattern instruction signal E307. On the other hand, when the detection flag indicates that the detection pattern has not been detected (that is, when “0” is set in the detection flag), the pattern instruction signal generator 315 outputs the pattern instruction signal E303 as the adjusted pattern instruction signal E307, provided that the output condition is satisfied, that is, only if the integration amount data E306 does not exceed the integration set value.

The adjusted pattern instruction signal E307 is used not only as a basis for the updating of the detection flag by the pattern detection flag update unit 313 but also for instructing the waveform error integrating unit 306 which of the patterns is an integration target.

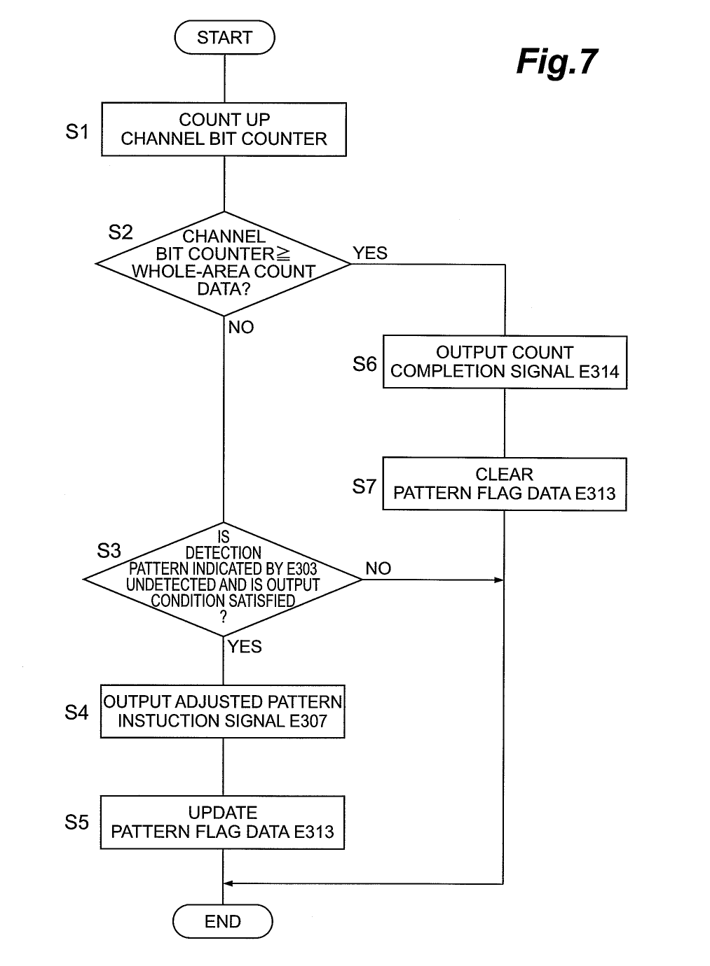

In the data recording and reproducing apparatus 1, the pattern count adjusting unit 307 described above executes the output adjustment operation according to the flowchart shown in FIG. 7, thereby adjusting the output of the adjusted pattern instruction signal E307. FIG. 7 is a flowchart showing the procedure for the operation of adjusting the output of the adjusted pattern instruction signal E307 executed by the pattern count adjusting unit 307. The pattern count adjusting unit 307 executes the operation according to the flowchart in FIG. 7 when receiving the pattern instruction signal E303.

Specifically, when receiving the pattern instruction signal E303, the pattern count adjusting unit 307 proceeds to block 1. At Block 1, the channel bit counter setting unit 314 counts up the channel bit counter in the above-described manner, and then executes the operation at block 2. At block 2, it is determined whether or not the channel bit counter is equal to the whole-area count data or more, and when the channel bit counter is equal to the whole-area count data or more, the operation at block 6 is executed, and otherwise, the operation at block 3 is executed.

At block 3, the pattern instruction signal generator 315 determines whether or not the detection pattern indicated by the pattern instruction signal E303 has been undetected and whether or not the output condition is satisfied, and when the detection pattern has been undetected and the output condition is satisfied, blocks 4, 5 are executed in sequence, and otherwise, the output adjustment operation is ended. At blocks 4, 5, the pattern instruction signal generator 315 outputs the adjusted pattern instruction signal E307 and the pattern detection flag update unit 313 updates the pattern flag data E313, and then the output adjustment operation is ended.

On the other hand, at block 6, the channel bit counter setting unit 314 outputs the count completion signal E314, and at subsequent block 7, the pattern detection flag update unit 313 clears the pattern flag data E313, and then the output adjustment operation is ended.

By executing the output adjustment operation in the above-described manner, the pattern count adjusting unit 307 adjusts the output of the adjusted pattern instruction signal E307 so that the adjusted pattern instruction signal E307 is outputted only once for each of the detection patterns during a period until the channel bit counter reaches the whole-area count data or more.

Therefore, in the data recording and reproducing apparatus 1, since the adjusted pattern instruction signal E307 is outputted once for each of the detection patterns during the period until the channel bit counter reaches the whole-area count data, the number of times the adjusted pattern instruction signal E307 is outputted is once for any of the detection patterns irrespective of their frequency of appearance.

Therefore, the difference among the detection patterns which occurs at the time of the integration of the data patterns by the waveform error integrating unit 306 is eliminated, and the data recording and reproducing apparatus 1 can evenly detect the detection patterns based on the reproduced signals corresponding to one rotation of the optical disk.

In this manner, the data recording and reproducing apparatus 1 prevents such a situation that the integration of the data patterns for a specific detection pattern is completed far earlier than for the other detection pattern due to the difference in the frequency of appearance.

Therefore, in the data recording and reproducing apparatus 1, even for the detection pattern with a low frequency of appearance, the integration of the data patterns is performed based on the reproduced signals corresponding to one rotation of the optical disk, which prevents a difference in learning accuracy among the detection patterns ascribable to the influence of the eccentricity and wobbling.

The above embodiment has described the example where, in setting the whole-area count data, the area corresponding to one rotation of the optical disk is defined as the target test write area, but an area corresponding to two rotations of the optical disk may be defined as a target test write area in setting the whole-area count data. In setting the whole-area count data, an area corresponding to any number of rotations of the optical disk may be defined as the target test write area, provided that the number of rotations is an integer number.

While certain embodiment of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data recording and reproducing apparatus comprising:
a reproduced signal output device configured to read data recorded on an optical recording medium and to output a reproduced signal; and
a waveform compensation amount data generating device configured to generate waveform correction amount data for a recording waveform corresponding to recording data which is to be recorded to the optical recording medium;
a waveform error integrating device configured to integrate, for each of one or more patterns, waveform error data which are used as a basis of the generation of the waveform correction amount data; and
an integration adjusting device configured to adjust an output of a pattern instruction signal for instructing said waveform error integrating device which of the one or more patterns is an integration target, so as to cause said waveform error integrating device to integrate, for each of the one or more patterns, the waveform error data in a target test write area corresponding to an integer number of rotations of the optical recording medium.

2. The data recording and reproducing apparatus according to claim 1, wherein said integration adjusting device is configured to adjust the output of the pattern instruction signal by using a whole-area set value which is set for the target test write area corresponding to the integer number of rotations of the optical recording medium.

3. The data recording and reproducing apparatus according to claim 1, wherein said integration adjusting device comprises:
a setting device configured to set a whole-area set value for the test write area corresponding to the integer number of rotations of the optical recording medium;
a channel bit counter update device configured to update a channel bit counter by adding the number of required channel bits every time a pattern is changed; and
a count completion signal output device configured to output a count completion signal when the channel bit counter reaches or exceeds the whole-area set value.

4. The data recording and reproducing apparatus according to claim 3, wherein said integration adjusting device further comprises a detection flag update device configured to update detection flags corresponding to each of the respective plurality of patterns, each of the detection flags indicating whether or not the corresponding pattern has been detected, said detection flag update device being configured to clear all the detection flags when receiving the count completion signal.

5. The data recording and reproducing apparatus according to claim 1, further comprising:
a delay device configured to delay the recording data to generate a delay signal; and
a pattern discriminating device configured to discriminate a pattern that matches or corresponds to the delay signal output from said delay device, and to output a pattern instruction signal to said integration adjusting device based on a result of the discrimination, wherein, when the pattern corresponding to the pattern instruction signal input from said pattern discriminating device is no longer detected, said integration adjusting device outputs the pattern instruction signal.

6. The data recording and reproducing apparatus according to claim 1, wherein said integration adjusting device has an inner and outer circumference setting register in which selection data is set, the selection data indicating an inner circumference or an outer circumference of the optical recording medium as the test write area, and said integration adjusting device being configured to change the test write area corresponding to the integer number of rotations of the optical recording medium to the inner circumference or to the outer circumference of the optical recording medium, according to the selection data set in said inner and outer circumference setting register.

7. A recording learning method in a data recording and reproducing apparatus which comprises:
a reproduced signal output device configured to read data recorded on an optical recording medium and to output a reproduced signal; and
a waveform compensation amount data generating device configured to generate waveform compensation amount data of a recording waveform corresponding to recording data which is to be recorded to the optical recording medium,
the method comprising:
integrating, for each one or more patterns, waveform error data which are used as a basis of the generation of the waveform compensation amount data by said waveform compensation amount data generating device; and
adjusting an output of a pattern instruction signal for instructing which of the patterns is an integration target, so as to integrate, for each of the one or more patterns, the waveform error data in a target test write area corresponding to an integer number of rotations of the optical recording medium.

8. The recording learning method according to claim 7, further comprising adjusting the output of the pattern instruction signal using a whole-area set value which is set for the target test write area corresponding to the integer number of rotations of the optical recording medium.
